(19) United States
(12) Patent Application Publication
(10) Pub. No.: US 2020/0043650 A1
(43) Pub. Date: Feb. 6, 2020

(54) ON-LOAD TAP CHANGING APPARATUS AND ON-LOAD TAP CHANGING SYSTEM

(71) Applicants: Kabushiki Kaisha Toshiba, Minato-ku (JP); Toshiba Energy Systems & Solutions Corporation, Kawasaki-shi (JP)

(72) Inventors: Naoki EGUCHI, Yokohama (JP); Takeshi CHIGIRI, Kawasaki (JP); Kei TAKANO, Kawaguchi (JP); Yasushi MIYAMOTO, Yokohama (JP)

(73) Assignees: Kabushiki Kaisha Toshiba, Minato-ku (JP); Toshiba Energy Systems & Solutions Corporation, Kawasaki-shi (JP)

(21) Appl. No.: 16/342,689

(22) PCT Filed: Oct. 21, 2016
(86) PCT No.: PCT/JP2016/081332

§ 371 Date: Apr. 17, 2019

(51) Int. Cl. H01F 29/04; H01H 9/00

(52) U.S. Cl. CPC H01F 29/04; H01H 9/0016

(57) ABSTRACT

An on-load tap changing apparatus includes a first switching unit connected to a first tap of a transformer provided in a power system and switching power supplied from the first tap, a first impedance changing unit connected in series with the first switching unit and increasing an impedance when the first switching unit executes a switching operation, a second switching unit connected to a second tap of the transformer and switching power supplied from the second tap, and a second impedance changing unit connected in series with the second switching unit and increasing an impedance when the second switching unit executes a switching operation. The on-load tap changing apparatus can suppress an arc at the time of switching, reduce deterioration of a switching unit, and have excellent durability.

### FIELD

Embodiments of the present disclosure relate to a tap switching apparatus and a tap switching system utilized for power receiving and transforming systems.

### BACKGROUND

In power systems, an on-load tap changing apparatus is utilized to adjust the voltage of a power transmission line or a power distribution line. Such an on-load tap changing apparatus includes a first switching unit connected to a first tap, and a second switching unit connected to a second tap.

### CITATION LIST

### Patent Literatures

Patent Document 1: JP 2016-139701 A

### SUMMARY

A transformer for transforming a voltage is installed in the power systems. This transformer is provided with a plurality of taps for outputting a plurality of voltages. In order to adjust the voltage of the power transmission line of the power system or the power distribution line thereof, it is necessary to switch the taps of the transformer by an on-load tap changing apparatus. The on-load tap changing apparatus includes the first switching unit connected to the first tap that outputs a first voltage, and the second switching unit connected to the second tap that outputs a second voltage. When adjusting the voltage, the first switching unit of the on-load tap changing apparatus is caused to be in an “open” state, and the second switching unit is caused to be in a “close” state.

However, since a large current flows through these first switching unit and second switching unit, when the first switching unit and the second switching unit are opened and closed, an arc is produced. This arc deteriorates the circuit switch contacts of the first switching unit and the second switching unit, and the insulating oils thereof.

An objective of embodiments of the present disclosure is to provide an on-load tap changing apparatus which suppresses an arc at the time of switching, reduces deterioration of a switching unit, and has an excellent durability.

An on-load tap changing apparatus according to an embodiment includes the following structures.

(1) A first switching unit connected to a first tap of a transformer provided in a power system, and switching power supplied from the first tap.

(2) A first impedance changing unit connected in series with the first switching unit, and increasing an impedance when the first switching unit executes a switching operation.

(3) A second switching unit connected to a second tap of the transformer, and switching power supplied from the second tap.

(4) A second impedance changing unit connected in series with the second switching unit, and increasing an impedance when the second switching unit executes a switching operation.

Moreover, an on-load tap changing system is which includes the above-described tap switching apparatus, a first primary circuit switch contact connected in parallel with the first switching unit of the on-load tap changing apparatus, and a second main switch contact connected in parallel with the second switching unit of the on-load tap changing apparatus.

### BRIEF DESCRIPTION OF DRAWINGS

FIG. 1 is a diagram illustrating an on-load tap changing system according to a first embodiment;

FIG. 2 is a perspective view from a lateral side illustrating an internal structure of an on-load tap changing apparatus according to the first embodiment;

FIG. 3 is a perspective view from an upper side illustrating the internal structure of the on-load tap changing apparatus according to the first embodiment;

FIG. 4 is a cross-sectional view for describing a first switching unit of the on-load tap changing apparatus according to the first embodiment;

FIG. 5 is an enlarged view for describing operations of the first switching unit of the on-load tap changing apparatus according to the first embodiment, a second switching unit thereof, and a impedance changing unit thereof;

FIG. 6 is a diagram illustrating a state of a drive unit for describing operations of the first switching unit of the on-load tap changing apparatus according to the first embodiment, the second switching unit thereof, and the impedance changing unit;

FIG. 7 is a time chart indicating the operating state of each component of the on-load tap changing apparatus according to the first embodiment; and

FIG. 8 is a diagram illustrating an on-load tap changing system according to another embodiment.

### DETAILED DESCRIPTION

### First Embodiment

[1. Structure]

[1-1. Structure of On-Load Tap Changing System]

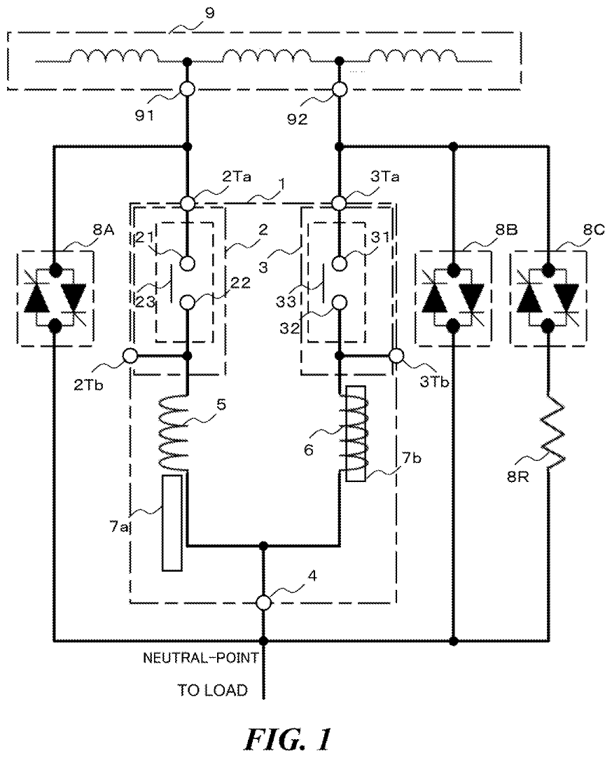

An on-load tap changing system that is an example according to this embodiment will be described with reference to FIG. 1. This system switches taps of a transformer installed in a power system to adjust the supply voltage of the power system. When a load connected to the power system changes, a supply current increases or decreases, and as a result, the supply voltage changes. The transformer installed in the power system is provided with a plurality of taps that output a plurality of voltages.

An on-load tap changing system includes a transformer 9, an on-load tap changing apparatus 1, a main switch contacts 8A, 8B, and 8C, and a transition resistor 8R.

The transformer 9 transforms the voltage of power supplied from a power generation plant or a substation into a voltage in accordance with a load. The transformer 9 includes taps 91 and 92 which output different voltages for voltage adjustment. The taps 91 and 92 are provided at winding portions of the transformer 9 which have different voltage transformation ratios, respectively, and the tap 92 outputs a voltage higher (referred to as a “high voltage” below) than that of the tap 91. The tap 91 outputs a voltage lower (referred to as a “low voltage” below) than that of the tap 92. A connection point connected to a load will be referred to as a neutral-point. The tap 91 corresponds to a first tap in claims, and the tap 92 corresponds to a second tap in the claims.

The main switch contact 8A includes a power switch like a thyristor. The main switch contact 8A is provided between the tap 91 of the transformer 9 at the low-voltage side, and the neutral-point at the load side. Switch control is executed on the main switch contact 8A by a switch control apparatus (unillustrated), and the power from the tap 91 of the transformer 9 to the neutral-point is flown or blocked.

The main switch contacts 8B is a power switch like a thyristor, and is provided between the tap 92 of the transformer 9 at the high-voltage side, and the neutral-point at the load side. Switch control is executed on the main switch contact 8B by the switch control apparatus (unillustrated), and the power from the tap 92 of the transformer 9 to the neutral is flown or blocked.

The main switch contact 8C is a power switch like a thyristor, is connected in series with the transition resistor 8R, and is provided between the tap 92 of the transformer 9 at the high-voltage side, and the neutral-point at the load side. Switch control is executed on the main switch contact 8C by the switch control apparatus (unillustrated), and the power from the tap 92 of the transformer 9 to the neutral-point is flown or blocked.

The transition resistor 8R is formed of a resistive element that has an electric resistance. The transition resistor 8R is connected in series with the main switch contact 8C, and is provided between the tap 92 of the transformer 9 at the high-voltage side, and the neutral-point at the load side. The transition resistor 8R limits the current that flows through the main switch contact 8C.

The on-load tap changing apparatus 1 is provided between the taps 91 and 92 of the transformer 9, and the neutral-point at the load side, and the power from the tap 91 of the transformer 9 to the neutral-point and the power from the tap 92 of the transformer 9 to the neutral-point is flown or blocked. The on-load tap changing apparatus 1 includes a first switching unit 2 (referred to as the “switching unit 2” below) and a second switching unit 3 (referred to as the “switching unit 3” below) connected to the taps 91 and 92 of the transformer 9, respectively, and a neutral terminal 4 connected to the neutral-point at the load side. In the figure, 2Ta is a terminal of the switching unit 2, and 3Ta is a terminal of the switching unit 3.

The on-load tap changing apparatus 1 includes a first impedance changing unit 5 (referred to as the “impedance changing unit 5”) connected in series with the switching unit 2, and a second impedance changing unit 6 (referred to as the “impedance changing unit 6”) connected in series with the switching unit 3.

The switching unit 2 is formed by a power switch like a vacuum valve that has a mechanical switch contact. The switch 2 is connected in series with the impedance changing unit 5, and is installed between the terminal 2Ta and the neutral-point terminal 4. In the On-load tap changing system, the switching unit 2 is connected between the tap 91 of the transformer 9 at the low-voltage side, and the neutral-point at the load side, and is connected in parallel with the main switch contact 8A outside the on-load tap changing apparatus 1. The switching unit 2 is controlled to be opened or closed by a drive unit to be described later and driven by the motor of the switch control apparatus (unillustrated), and flows or blocks the power from the tap 91 of the transformer 9 to the neutral-point. The switching unit 3 employs the same structure as that of the switching unit 2.

The impedance changing unit 5 is formed by an inductor that has a coil wound around a bobbin. The impedance changing unit 5 is provided between the switching unit 2 and the neutral-point terminal 4. A core 7a to be described later is inserted in the bobbin of the inductor of the impedance changing unit 5. The relative position between the core 7a and the coil is changeable, and by changing the relative position between the core 7a and the coil, the impedance of the impedance changing unit 5 relative to the frequency of the supplied power is changed. The impedance changing unit 5 changes the current that flows through the switching unit 2 by changing the impedance. The impedance changing unit 6 employs the same structure as that of the impedance changing unit 5.

[1-2. Mechanical Structure of On-Load Tap Changing Apparatus]

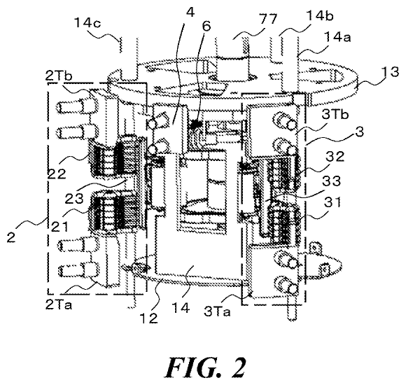

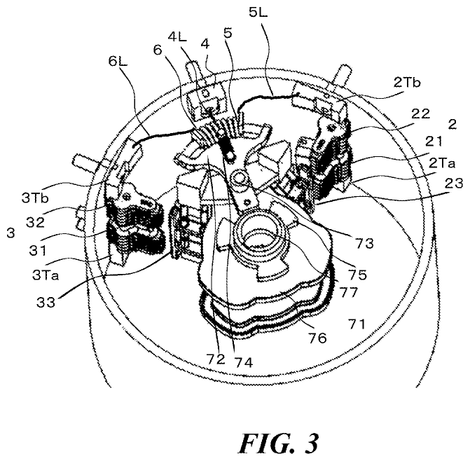

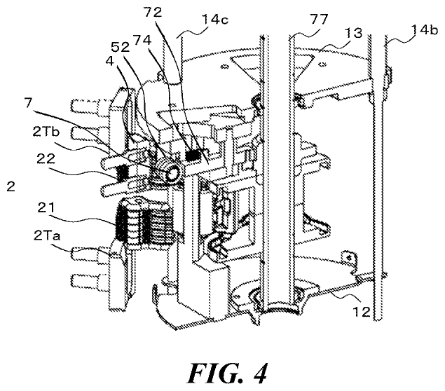

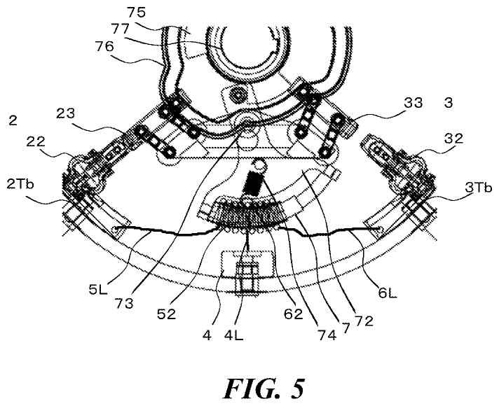

The detailed structure of the on-load tap changing apparatus 1 will be described with reference to FIGS. 2 to 5. FIG. 2 illustrates the internal structure according to the first embodiment. The on-load tap changing apparatus 1 is fastened inside a tank (unillustrated) which is maintained in a vacuum condition. The terminals 2Ta and 2Tb that are parts of the first switching unit 2, the terminals 3Ta and 3Tb that are parts of the second switching unit 3, and the neutral-point terminal 4 connected to the neutral-point at the load side are exposed outside the tank, as connection portions.

The tap 91 of the transformer 9 is connected to the terminal 2Ta, and the tap 92 of the transformer 9 is connected to the terminal 3Ta, respectively. A load is connected to the neutral-point terminal 4. The on-load tap changing apparatus 1 includes, as an example, the switching unit 2, the impedance changing unit 5, the switching unit 3, the impedance changing unit 6, a core 7, a drive unit 71, and the neutral-point terminal 4.

The on-load tap changing apparatus 1 includes a frame 11 that is formed of an insulating material, and each of the above-described components are fastened to this frame 11. The frame 11 includes a lower shaft receiving plate 12 which is placed at the lower side and in a substantially disk shape, an intermediate plate 13 which is placed at the upper side and in a disk shape, and support shafts 14a, 14b, and 14c which are inserted through and fastens the lower shaft receiving plate 12 and the intermediate plate 13 and in a cylindrical shape. Moreover, this frame 11 includes a break unit holder 14 which is held and fastened between the lower shaft receiving plate 12 and the intermediate plate 13 and in a frame shape. The switching unit 2, the impedance changing unit 5, the switching unit 3, the impedance changing unit 6, the core 7, and the drive unit 71 are placed on this frame 11. The frame 11 is fastened inside the tank (unillustrated) in a cylindrical shape and which is maintained in the vacuum condition.

(1. Structures of Switching Unit 2 and Switching Unit 3)

The switching unit 2 and the switching unit 3 have the same mechanical structure. The structures thereof will be described with reference to the switching unit 2 as an example below.

The switching unit 2 includes the terminal 2Ta, a contactor 21, the terminal 2Tb, a contactor 22, and a conductor 23. Each component of the switching unit 2 is fastened to the frame 11 in the order of, from the lower shaft receiving plate 12 to the intermediate plate 13, the terminal 2Ta, the contactor 21, the contactor 22, and terminal 2Tb. The conductor 23 is connected to and held by the drive unit 71 fastened to the frame 11. The terminal 2Ta of the switching unit 2 is connected to the tap 91 of the transformer 9 at the low-voltage side and outside the on-load tap changing apparatus 1, and the terminal 2Tb is connected to the impedance changing unit 5. The switching unit 2 flows or blocks the power from the tap 91 of the transformer 9 to the neutral-point at the load side.

The terminals 2Ta and 2Tb are each formed of copper and formed in a block shape that is a cuboid shape. The terminals 2Ta and 2Tb each have two connection protrusions provided with a male thread like a bolt. The two protrusion of the terminals 2Ta and 2Tb are placed up and down in parallel to each other in the lengthwise direction of the block shape that is a cuboid shape, and protrude from the external surface of the cylindrical tank when the frame 11 is fastened to the cylindrical tank. The terminals 2Ta and Tb are respectively connected to the contactor 21 and the contactor 22 by copper plates in the on-load tap changing apparatus 1. The two protrusions of the terminal 2Ta are connected to the tap 91 of the transformer 9 at the low-voltage side and outside the on-load tap changing apparatus 1.

The contactors 21 and 22 are each an electrode contact formed by combining a plurality of copper plates. The plurality of copper plates of each contactor 21 and 22 is curved in spring plate shape to have elasticity, and the plurality of copper plates is aligned in the vertical direction and fastened to a base by screws. The contactor 21 is connected to the terminal 2Ta by a copper plate, the contactor 22 is connected to the terminal 2Tb by a copper plate, and they are fastened to the frame 11.

The conductor 23 is driven by the drive unit 71, and when the conductor 23 contacts the contactor 21 and the contactor 22, an electrical connection is established between the terminals 2Ta and 2Tb. The plurality of copper plates of each contactor 21 and contactor 22 is each curved in spring plate shape to have elasticity, and ensures a contact between the conductor 23 and the contactors 21 and 22.

Moreover, the conductor 23 is driven by the drive unit 71, and the conductor 23 is separated from the contactor and the contactor 22. This achieves an electrical disconnection between the terminal 2Ta and 2Tb.

(2. Structures of Impedance Changing Unit 5 and Impedance Changing Unit 6)

The impedance changing unit 5 and the impedance changing unit 6 have the same mechanical structure. The structures thereof will be described with reference to the impedance changing unit 5 as an example below.

The impedance changing unit 5 includes an inductor that has a coil 52 of a copper wire wound around a bobbin 51 formed of an insulator like a resin. The bobbin 51 is formed in a curved cylindrical shape that has a curvature equivalent to that of the rotation radius of a core arm 72 of the drive unit 71 to be described later. The coil 52 is wound around this bobbin 51 and similarly has the curved shape. Note that the bobbin 51 is integrally formed with a bobbin 61 of the impedance changing unit 6 to be described later.

The impedance changing unit 5 has one side connected to the terminal 2Tb of the switching unit 2 via a lead wire 5L, and has the other side connected to the neutral-point terminal 4 via a lead wire 4L. In the impedance changing unit 5, a core 7 to be described later is inserted in the bobbin 51 around which the coil 52 is wound. The relative position between the core 7 and the coil 52 is changeable, and by changing the relative position between the core 7 and the coil 52 by the drive unit 71, the impedance of the impedance changing unit 5 relative to the frequency of the supplied power is changed in accordance with the changed 2. The impedance changing unit 5 changes the current that flows between terminal 2Ta of the on-load tap changing apparatus 1 and the neutral-point terminal 4 when the impedance is changed.

(3. Structure of Core 7)

The core 7 is a member for collecting magnetism and is formed of a magnetic material like iron. The core 7 is formed in a curved cylindrical shape that has the curvature equivalent to that of the rotation radius of the core arm 72 of the drive unit 71 to be described later. The core 7 has a circular cylindrical diameter which allows the core 7 to be movable in the bobbin 51 of the impedance changing unit 5, and in the bobbin 61 of the impedance changing unit 6. Moreover, the core 7 is formed in a circular cylindrical shape that has a length corresponding to a total length of the coil 52 of the impedance changing unit 5 and the coil 62 of the impedance changing unit 6. Note that the core 7 employs a structure in which the core 7a and the core 7b in FIG. 1 are integrated with each other.

The core 7 is held by the core arm 72 of the drive unit 71 to be described later. The core 7 moves in the bobbin 51 of the impedance changing unit 5 and in the bobbin 61 of the impedance changing unit 6 when the core arm 72 is rotated.

The impedance changing unit 5 becomes high impedance when the core 7 is placed inside the coil 52 of the bobbin 51 of the impedance changing unit 5. The variable impedance unit 5 becomes low impedance when the core 7 is placed outside the coil 52 of the impedance changing unit 5.

The impedance changing unit 6 becomes high impedance when the core 7 is placed inside the coil 62 of the bobbin 61 of the impedance changing unit 6. The impedance changing unit 6 becomes low impedance when the core 7 is placed outside the coil 62 of the impedance changing unit 6.

(4. Structure of Drive Unit 71)

The drive unit 71 includes the core arm 72, an arm shaft 73, a spring 74, a core cam 75, a switch cam 76, and a cam shaft 77.

The cam shaft 77 is a cylindrical shaft formed of an insulating material like a resin. The cam shaft 77 the lower portion inserted in the lower shaft receiving plate 12 and the upper portion inserted in the intermediate plate 13, and is placed in rotatably movable manner. The core cam 75 and the switch cam 76 are fastened to the cam shaft 77. The cam shaft 77 is driven by the external switch control apparatus (unillustrated) when the switching unit 2 and the switching unit 3 are opened or closed.

The switch cam 76 is formed of an insulating material like a resin, and is formed in a bell-crank shape having concavities and convexities in the radial direction. The radial center portion of the switch cam 76 is fastened to the cam shaft 77, and the outer circumference of the switch cam 76 is placed to abut the conductor 23 of the switching unit 2 and the conductor 33 of the switching unit 3. The switch cam 76 moves the conductor 23 of the switching unit 2 and the conductor 33 of the switching unit 3 outwardly and inwardly in the radial direction relative to the camshaft 77 when the cam shaft 77 is rotated.

The conductor 23 that has been moved outwardly in the radial direction relative to the cam shaft 77 is pushed against the contactor 21 and the contactor 22, and the switching unit 2 becomes a “close” state. The conductor 23 that has been moved inwardly in the radial direction relative to the cam shaft 77 is apart from the contactor 21 and the contactor 22, and the switching unit 2 becomes an “open” state.

The conductor 33 that has been moved outwardly in the radial direction relative to the cam shaft 77 is pushed against the contactor 31 and the contactor 32, and the switching unit 3 becomes the “close” state. The conductor 33 that has been moved inwardly in the radial direction relative to the cam shaft 77 is apart from the contactor 31 and the contactor 32, and the switching unit 3 becomes the “open” state.

The core cam 75 is formed of an insulating material like a resin, and is formed in a shape that has radial concavities and convexities in the radial direction. The radial center portion of the core cam 75 is fastened to the cam shaft 77, and the concavities and convexities of the core cam 75 are placed to abut the core arm 72. The core cam 75 rotates the core arm 72 when the cam shaft 77 is rotated.

The core arm 72 is formed of an insulating material like a resin, and supports the core 7. The core arm 72 supports the core 7 at two bottom surfaces of the curved cylindrical shape of the core 7. Moreover, the core arm 72 has an arm portion, and is placed in rotatably movable manner by the arm shaft 73 fastened to the intermediate plate 13 that is provided at the arm portion. The core cam 75 rotates together with the cam shaft 77, and this core cam 75 pushes the arm portion of the core arm 72. Accordingly, the core arm 72 rotates around the arm shaft 73 as a center. The rotation of the core arm 72 causes the core 7 to move inside the bobbin 51 of the impedance changing unit 5 and the bobbin 61 of the impedance changing unit 6.

Note that when the core cam 75 is not pushing the core arm 72, the core arm 72 is pulled back by the spring 74 so that the core 7 is located in the coil 52 of the impedance changing unit 5 and the coil 62 of the impedance changing unit 6.

[2. Action]

[2-1. Action of On-Load Tap Changing System]

Next, the outline of an operation of the on-load tap changing system according to this embodiment will be described with reference to FIG. 1. As an example, an operation when the load current increases and the tap of the transformer 9 is changed from the tap 91 at the low-voltage side to the tap 92 at the high-voltage side will be described.

As an initial state, the power is supplied to the load from the tap 91 of the transformer 9 at the low-voltage side. The state of each component in this stage is as follows.

Main switch contacts 8A: “close”, 8B: “open”, and 8C: “open”.

On-load tap changing Apparatus 1, Switching unit 2: “close”, and Switching unit 3: “open”.

Impedance changing unit 5: “low impedance”, and Impedance changing unit 6: “high impedance”.

In this state, the impedance of the impedance changing unit 5 is substantially 1/10 of the impedance when the main switch contact 8A is in the “close” state.

Next, the impedance of the impedance changing unit 5 is increased.

The state of each component in this stage is as follows.

Main switch contacts 8A: “close”, 8B: “open”, and 8C: “open”.

On-load tap changing Apparatus 1, Switching unit 2: “close”, and Switching unit 3: “open”.

Impedance changing unit 5: “high impedance”, and Impedance changing unit 6: “high impedance”.

The impedance of the impedance changing unit 5 is substantially 10 times as much as the impedance when the main switch contact 8A is in the “close” state. Hence, the current that flows through the switching unit 2 is reduced to substantially 1/10 of the current that flows through the main switch contact 8A.

Next, the switching unit 2 of the on-load tap changing apparatus 1 is changed to the “open” state.

The state of each component in this stage is as follows.

Main switch contacts 8A: “close”, 8B: “open”, and 8C: “open”.

On-load tap changing Apparatus 1, Switching unit 2: “open”, and Switching unit 3: “open”.

Impedance changing unit 5: “high impedance”, and Impedance changing unit 6: “high impedance”.

This shifts the current supplied from the tap 91 of the transformer 9 at the low-voltage side from the switching unit 2 to the main switch contact 8A (this operation will be referred to as a “commutation”). Since the current subjected to the commutation is suppressed, a damage to the switching unit 2 when opened is reduced.

Next, the main switch contact 8C is changed to the “close” state.

The state of each component in this stage is as follows.

Main switch contacts 8A: “close”, 8B: “open”, and 8C: “close”.

On-load tap changing Apparatus 1, Switching unit 2: “open”, and Switching unit 3: “open”.

Impedance changing unit 5: “high impedance”, and Impedance changing unit 6: “high impedance”.

Hence, the current from the tap 91 of the transformer 9 at the low-voltage side flows to the load via the main switch contact 8A, and the current from the tap 92 of the transformer 9 at the low-voltage side flows to the load via the main switch contact 8C and the transition resistor 8R. The tap 91 of the transformer 9 at the low-voltage side and the tap 92 at the low-voltage side are connected to each other via the transition resistor 8R, and this state is called a “bridge.”

Next, the main switch contact 8A is changed to the “open” state.

The state of each component in this stage is as follows.

Main switch contacts 8A: “open”, 8B: “open”, and 8C: “close”.

On-load tap changing Apparatus 1, Switching unit 2: “open”, and Switching unit 3: “open”.

Impedance changing unit 5: “high impedance”, and Impedance changing unit 6: “high impedance”.

Hence, the current that flows to the load all becomes the current which has flown from the tap 92 of the transformer 9 at the low-voltage side via the main switch contact 8C and the transition resistor 8R.

Next, the main switch contact 8B is changed to the “close” state.

The state of each component in this stage is as follows.

Main switch contacts 8A: “open”, 8B: “close”, and 8C: “close”.

On-load tap changing Apparatus 1, Switching unit 2: “open”, and Switching unit 3: “open”.

Impedance changing unit 5: “high impedance”, and Impedance changing unit 6: “high impedance”.

Hence, the current that flows to the load becomes the current which has flown from the tap 92 of the transformer 9 at the low-voltage side via the main switch contact 8B, and the main switch contact 8C and the transition resistor 8R provided in parallel with the aforementioned main switch contact 8B.

Next, the switching unit 3 of the on-load tap changing apparatus 1 is changed to the “close” state.

The state of each component in this stage is as follows.

Main switch contacts 8A: “open”, 8B: “close”, and 8C: “close”.

On-load tap changing Apparatus 1, Switching unit 2: “open”, and Switching unit 3: “close”.

Impedance changing unit 5: “high impedance”, and Impedance changing unit 6: “high impedance”.

Hence, the current from the tap 92 of the transformer 9 at the low-voltage side also flows through the switching unit 3 of the on-load tap changing apparatus 1. At this stage, the impedance of the impedance changing unit 6 is substantially 10 times as much as the impedance when the main switch contact 8B is in the “close” state. Hence, the current that flows through the switching unit 3 is substantially 1/10 of the current that flows through the main switch contact 8B. Since the current subjected to the commutation to the switching unit 3 from the main switch contact 8B is suppressed, a damage to the switching unit 3 when opened is reduced.

Next, the impedance of the impedance changing unit 6 is reduced.

The state of each component in this stage is as follows.

Main switch contacts 8A: “open”, 8B: “close”, and 8C: “close”.

On-load tap changing Apparatus 1, Switching unit 2: “open”, and Switching unit 3: “close”.

Impedance changing unit 5: “high impedance”, and Impedance changing unit 6: “low impedance”.

The impedance of the impedance changing unit 6 becomes substantially 1/10 of the impedance when the main switch contact 8B is in the “close” state. Hence, the current that flows through the switching unit 3 becomes substantially 10 times as much as the current that flows through the main switch contact 8B. Since the majority of the current from the tap 92 of the transformer 9 at the high-voltage side flows to the switching unit 3, all procedures of tap switching completes.

The main switch contacts 8A, 8B, and 8C are each include a thyristor. Since the thyristor generates heat when a large current flows therethrough for a long time, a cooling is necessary. Hence, it is preferable to reduce a time for the current to flow only through the main switch contacts 8A, 8B, and 8C, and it is preferable that a time for tap switching is substantially several 100 ns to 1 second.

[2-2. Action of On-Load Tap Changing Apparatus 1]

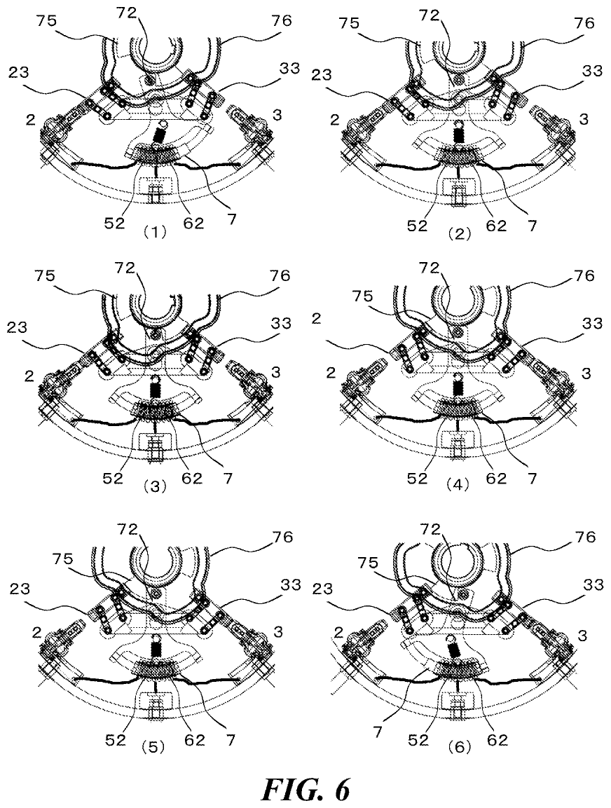

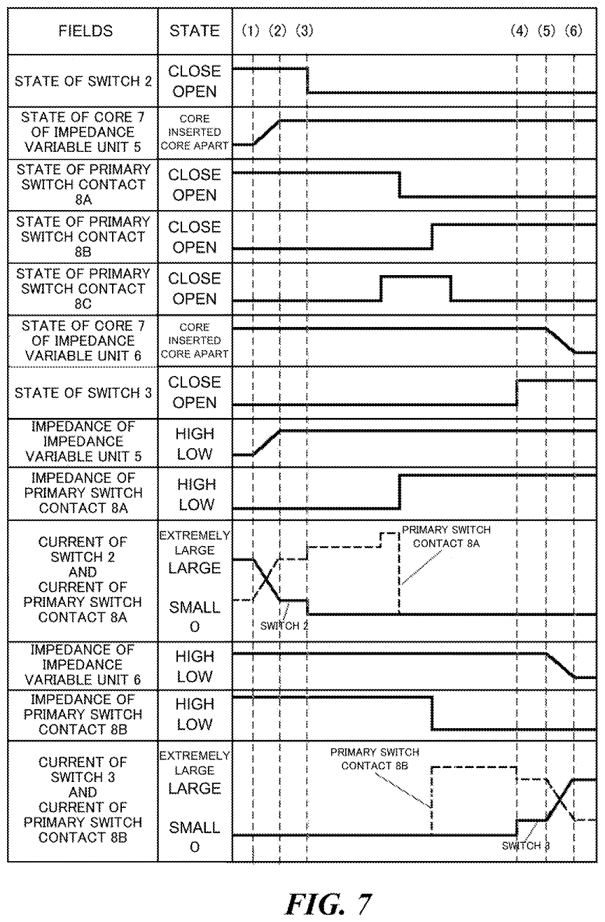

Next, an operation of the on-load tap changing apparatus 1 according to this embodiment will be described with reference to FIGS. 6 to 7. The following description is given for an example operation when this on-load tap changing apparatus 1 is installed in the on-load tap changing system illustrated in FIG. 1.

The switching unit 2 and switching unit 3 of the on-load tap changing apparatus 1 are driven by the drive unit 71, and execute switching operations. The impedance changing unit 5 and the impedance changing unit 6 are driven by the drive unit 71, and execute impedance increasing and decreasing operations. The drive unit 71 controls the switching operations of the switching unit 2 and the switching unit 3 and the impedance increasing and decreasing operations of the impedance changing unit 5 and the impedance changing unit 6, when the cam shaft 77 of the drive unit 71 is rotated and driven by the external switch control device (unillustrated).

The drive unit 71 switches the switching unit 2 and the switching unit 3 using the switch cam 76 connected to the cam shaft 77. The drive unit 71 drives the core arm 72 where the core 7 is placed using the core cam 75 connected to the cam shaft 77. The core arm 72 causes the core 7 to be inserted in and to be apart from the respective bobbins 51 and 61 of the coils 52 and 62 of the impedance changing unit 5 and the impedance changing unit 6, thereby increasing or decreasing the impedance of the impedance changing unit 5 and the impedance changing unit 6.

The switch cam 76 and the core cam 75 are both connected to the cam shaft 77, and timings of the switching operations of the switching unit 2 and the switching unit 3 and the impedance increasing and decreasing operations of the impedance changing unit 5 and impedance changing unit 6 are controlled by the switch cam 76 and the core cam 75. Consequently, the impedance changing unit 5 becomes high impedance at the time of the switching operations of the switching unit 2, and the impedance changing unit 6 becomes high impedance at the time of the switching operations of the switching unit 3. In contrast, when the switching units 2 and 3 do not execute the switching operations and the power is normally supplied to the load, the impedance changing units 5 and 6 become low impedance.

Next, as an example, an operation procedure when the load current increases and the tap of the transformer 9 is changed from the tap 91 at the low-voltage side to the tap 92 at the high-voltage side will be described. The following stages (1) to (6) respectively corresponds to (1) to (6) in time charts of FIG. 6 and FIG. 7.

(1) As an initial state, the power is supplied to the load via the switching unit 2 and the neutral-point terminal 4 from the tap 91 of the transformer 9 at the low-voltage side. The state of each component in this stage is as follows.

Switching unit 2: “close”, and Switching unit 3: “open”.

Interior of Coil 52 of Impedance changing unit 5: core 7 absent.

Interior of Coil 62 of Impedance changing unit 6: core 7 present.

Impedance changing unit 5: “low impedance”, and Impedance changing unit 6: “high impedance”.

The core 7 is apart from the bobbin 51 of the impedance changing unit 5, and the impedance changing unit 5 that has the coil 52 is low impedance. Therefore, the current that flows through the switching unit 2 is large.

(2) Next, the cam shaft 77 of the drive unit 71 is rotated by an external device, and the core cam 75 and the switch cam 76 both connected to the cam shaft 77 are rotated. The core cam 75 rotates the core arm 72, and moves the core 7. The core 7 is inserted in the bobbin 51 of the impedance changing unit 5, and the impedance changing unit 5 that has the coil 52 becomes high impedance. The state of each component in this stage is as follows.

Switching unit 2: “close”, and Switching unit 3: “open”.

Interior of Coil 52 of Impedance changing unit 5: core 7 present.

Interior of Coil 62 of Impedance changing unit 6: core 7 present.

Impedance changing unit 5: “high impedance”, and Impedance changing unit 6: “high impedance”.

Note that the core 7 is rotated by the force of the spring 74 installed on the core arm 72. This operation decreases the current that flows through the switching unit 2. In contrast, the current that flows through the main switch contact 8A connected to the tap 91 of the transformer 9 at the high-voltage side increases.

(3) Next, the cam shaft 77 of the drive unit 71 is further rotated by the external device, and the core cam 75 and the switch cam 76 both connected to the cam shaft 77 are rotated. The switch cam 76 pulls the conductor 23 of the switching unit 2 inwardly in the radial direction, and causes the switching unit 2 to be the “open” state. The state of each component in this stage is as follows.

Switching unit 2: “open”, and Switching unit 3: “open”.

Interior of Coil 52 of Impedance changing unit 5: core 7 present.

Interior of Coil 62 of Impedance changing unit 6: core 7 present.

Impedance changing unit 5: “high impedance”, and Impedance changing unit 6: “high impedance”.

Hence, the current stops to flow through the switching unit 2. The current from the tap 91 of the transformer 9 at the low-voltage side all flows to the load via the main switch contact 8A.

Subsequently, the main switch contact 8C connected in series with the transition resistor 8R is changed to the “close” state. Next, the main switch contact 8A is changed to the “open” state. Furthermore, the main switch contact 8B is changed to the “close” state. Hence, the current that flows to the load is changed from the current supplied from the tap 91 of the transformer 9 at the low-voltage side to the current supplied from the tap 92 at the high-voltage side.

(4) Next, the cam shaft 77 of the drive unit 71 is further rotated by the external device, and the core cam 75 and the switch cam 76 both connected to the cam shaft 77 are rotated. The switch cam 76 pushes out the conductor 33 of the switching unit 3 outwardly in the radial direction, and causes the switching unit 3 to be the “close” state. The state of each component in this stage is as follows.

Switching unit 2: “open”, and Switching unit 3: “close”.

Interior of Coil 52 of Impedance changing unit 5: core 7 present.

Interior of Coil 62 of Impedance changing unit 6: core 7 present.

Impedance changing unit 5: “high impedance”, and Impedance changing unit 6: “high impedance”.

Hence, the current starts flowing through the switching unit 3. At this stage, since the impedance changing unit 6 is high impedance, the current that flows through the switching unit 3 is small. In contrast, the current that flows through the main switch contact 8B is large.

(5) Next, the cam shaft 77 of the drive unit 71 is rotated by the external device, and the core cam 75 and the switch cam 76 both connected to the cam shaft 77 are rotated. The core cam 75 rotates the core arm 72, and moves the core 7. The core 7 starts to be apart from the bobbin 61 of the impedance changing unit 6.

(6) Furthermore, the cam shaft 77 of the drive unit 71 is rotated by the external device, and the core cam 75 rotates the core arm 72, and moves the core 7. The core 7 becomes apart from the bobbin 61 of the impedance changing unit 6. The state of each component in this stage is as follows.

Switching unit 2: “open”, and Switching unit 3: “close”.

Interior of Coil 52 of Impedance changing unit 5: core 7 present.

Interior of Coil 62 of Impedance changing unit 6: core 7 absent.

Impedance changing unit 5: “high impedance”, and Impedance changing unit 6: “low impedance”.

Hence, since the impedance changing unit 6 becomes low impedance, the current that flows through the switching unit 3 becomes large. In contrast, the current that flows through the main switch contacts 8B and 8C becomes small. The large current can flow through the switching unit 3 from the tap 92 of the transformer 9 at the high-voltage side, and all procedures of tap switching completes.

In comparison with the main switch contact 8A, 8B, or 8C, the impedance changing unit 5 or 6 has the impedance that is substantially 10 times when being high impedance, and has the impedance that is substantially 1/10 times when being low impedance. An inductor of such a impedance changing unit 5 or 6 can be achieved as follows. The description will be given of the inductor of the impedance changing unit 5 or 6 as an example below.

The reactance of the inductor: X [Ω] can be expressed as follows.

X=2πfL (1)

where:

f: AC Frequency [Hz], and

L: Inductance [H].

In this case, L is as follows.

L=k·μ0·n\hat{ }2·πa\hat{ }2/b (2)

where:

k: NAGAOKA Coefficient,

μ0: Permeability (vacuum permeability x relative permeability),
Vacuum Permeability is 4π×10\hat{ }-7,
Pneumatic Relative Permeability is 1, and
Ferrite Core Relative Permeability is 600.

n: Number of Turns of Coil,

a: Coil Winding radius, and

b: Coil Winding length.

In this case, as an example, each parameter is set to the following value.

a: 5 mm.

b: 20 mm.

n: 4.5.

k: 0.82.

L=0.082 μH.
49.2 μH.

X=25.7 μΩ (when empty), and
15 mΩ (when ferrite core has entered)

The resistance when the switching unit 2 or 3 is in the “close” state is substantially 150 μΩ.

Moreover, the resistance when the main switch contact 8A, 8B, or 8C is in the “close” state is substantially 1.5 mΩ.

In comparison with the impedance of the impedance changing unit 5 or 6, the following can be achieved.

When low impedance, Impedance of Switch: Impedance of Main switch contact=substantially 1:10.

When high impedance, Impedance of Switch: Impedance of Main switch contact=substantially 10:1.

Thus, the impedance changing unit 5 or 6 according to this embodiment can be achieved as described above.

[3. Effects]

(1) According to this embodiment, the impedance changing unit 5 connected to the switching unit 2 or the impedance changing unit 6 connected to the switching unit 3 is changed to the high impedance state to execute switching of the switching unit 2 or the switching unit 3, an arc when the circuit is opened and closed is reduced, the deterioration of the switching unit is reduced, and the on-load tap changing apparatus that has an excellent durability can be provided.

(2) According to this embodiment, since the impedance of the impedance changing unit of the on-load tap changing apparatus is variable by inserting or moving apart the core in or from the bobbin of the inductor formed of the bobbin around which the coil is wound, the impedance changing unit itself of the on-load tap changing apparatus 1 has no switch structure. Hence, in the impedance increasing and decreasing operations by the impedance changing units 5 and 6, switch of the current is not executed, and the current to the load is not cut off, and thus the deterioration of the impedance changing unit 5, 6 itself is reduced. Moreover, the impedance changing units 5 and 6 are can be achieved by a simple structure, and thus an increase in number of components of the on-load tap changing apparatus 1 is prevented, and a failure rate thereof is reduced.

(3) According to this embodiment, since the drive unit 71 drives the switching unit 2, the switching unit 3, the impedance changing unit 5, and the impedance changing unit 6 in conjunction to ensure the timings at which the impedance changing unit 5 becomes high impedance at the time of the switching operation of the switching unit 2 and the impedance changing unit 6 becomes high impedance at the time of the switching operation of the switching unit 3. In contrast, the impedance changing units 5 and 6 are controlled to be low impedance when the switching units 2 and 3 do not execute the switching operations and the power is normally supplied to the load.

(4) The coil 52 of the impedance changing unit 5 and the coil 62 of the impedance changing unit 6 are connected in series via the neutral-point and wound around the common bobbin, and the core 7 that is caused to move in the bobbin is formed of a single core common to the coils 52 and 62, and thus the structure is simplified, an increase in number of components of the on-load tap changing apparatus 1 is prevented, and a failure rate thereof is also reduced.

### 4. OTHER EMBODIMENTS

Although the embodiment of the present disclosure that includes the modified example thereof has been described, such embodiment is merely presented as an example, and is not intended to limit the scope of the present disclosure. Such embodiment can be carried out in other various forms, and various omissions, replacements, and modifications can be made thereto without departing from the scope of the present disclosure. Such embodiment and the modified form thereof are within the scope of the present disclosure, and also within the scope of the invention as recited in the appended claims and the equivalent range thereto. The followings are examples thereof.

(1) In the above-described embodiment, although the number of taps of the transformer 9 is two that are the taps 91 and 92, the number of taps is not limited to this case. The transformer 9 may have three or more taps.

(2) In the above-described embodiment, although the switching units 2 and 3 are vacuum valves, those may be an oil circuit breaker.

(3) In the above-described embodiment, although the impedance changing units 5 and 6 are the inductors, the impedance variable scheme is not limited to this case. Other resistance variable elements may be applied.

(4) Although the bobbins 51 and 61 of the impedance changing units 5 and 6 are in the integral structure with a curved shape in the above-described embodiment, the structure of the bobbin is not limited to this case. The bobbins 51 and 61 may be formed in a linear shape instead of a curved shape. Moreover, those may not be integrated with each other, and may be separate components.

(5) Although the core 7 is in the integral structure with a curved shape in the above-described embodiment, the shape of the core is not limited to this case. The core 7 may be formed in a linear shape instead of a curved shape.

Moreover, the core 7 may not employ a structure in which the core 7a and the core 7b are integrated with each other. The core 7a and the core 7b may be separate components.

(6) In the above-described embodiment, although the core 7 is moved via the core arm 72 by the core cam 75, the movement mechanism of the core 7 is not limited to this structure. For example, the core cam placed on the cam shaft 77 may not be used, and a mechanism independent from the switching of the switching units 2 and 3 may be provided to move the core 7.

(7) In the above-described embodiment, although the on-load tap changing apparatus 1 is installed in the on-load tap changing system illustrated in FIG. 1, the system that utilizes this on-load tap changing apparatus 1 is not limited to such a system. For example, the on-load tap changing apparatus 1 alone may be installed in a power system.

(8) In the above-described embodiment, the description has been given of the case in which the tap of the transformer 9 is changed from the tap 91 at the low-voltage side to the tap 92 at the high-voltage side, the impedance changing unit 5 becomes high impedance when the switching unit 2 of this on-load tap changing apparatus 1 is in the “open” state, and the impedance changing unit 6 becomes high impedance when the switching unit 3 is in the “close” state.

When the tap of the transformer 9 is changed from the tap 92 at the high-voltage side to the tap 91 at the low-voltage side, and when the switching unit 3 of the on-load tap changing apparatus 1 becomes the “open” state, the impedance changing unit 6 also becomes high impedance, and when the switching unit 2 becomes the “close” state, the impedance changing unit 5 also becomes high impedance. That is, when the switching units 2 and 3 changes from the “open” state to the “close” state, and from the “close” state to the “open” state, the impedance changing units 5 and 6 become high impedance. In contrast, when the switching units 2 and 3 do not execute the switching operations, and the power is normally supplied to the load, the impedance changing units 5 and 6 become low impedance.

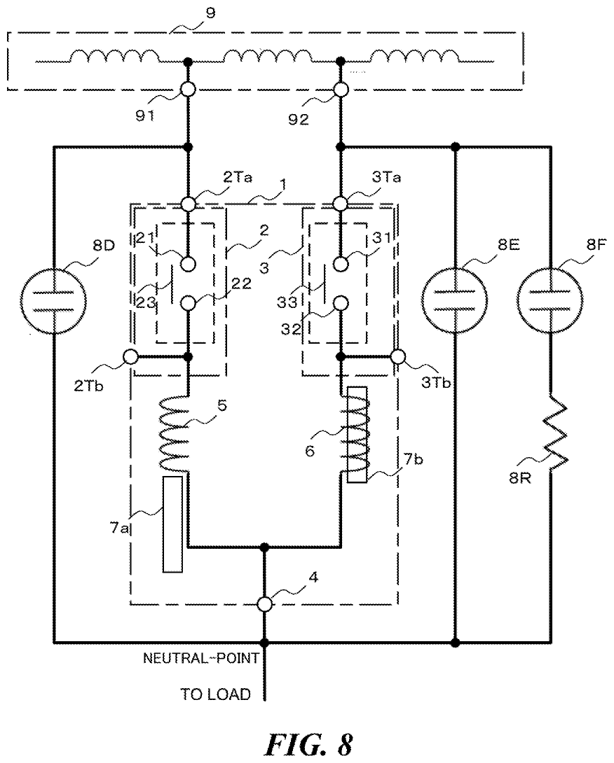

(9) In the above-described embodiment, as shown in FIG. 1, although the main switch contacts 8A, 8B, and 8C of the on-load tap changing system each include a semiconductor switch like a thyristor, as illustrated in FIG. 8, those may be each a switch that has a mechanical contact.

### REFERENCE SIGNS LIST

1 On-load tap changing apparatus
2, 3 Switching unit
2Ta, 2Tb, 3Ta, 3Tb Terminal
21, 22, 31, 32 Contactor
23, 33 Conductor
4 Neutral Terminal
4L, 5L, 6L Lead wire
5, 6 Impedance changing unit
51, 61 Bobbin
52, 62 Coil
7 Core
71 Drive unit
72 Core arm
73 Arm shaft
74 Spring
75 Core cam
76 Switch cam
77 Cam shaft
8A, 8B, 8C Main switch contact
8R Transition resistor
7, 7a, 7b Core
9 Transformer
91, 92 Tap
71 Drive unit
11 Frame
12 Lower shaft receiving plate
13 Intermediate plate
14 Break unit holder
14a, 14b, 14c Support shaft

1. An on-load tap changing apparatus comprising:
a first switching unit connected to a first tap of a transformer provided in a power system, and switching a power supplied from the first tap;
a first impedance changing unit connected in series with the first switching unit, and increasing an impedance when the first switching unit executes a switching operation;
a second switching unit connected to a second tap of the transformer, and switching a power supplied from the second tap; and
a second impedance changing unit connected in series with the second switching unit, and increasing an impedance when the second switching unit executes a switching operation.

2. The on-load tap changing apparatus according to claim 1, further comprising a drive unit driving the first switching unit, the second switching unit, the first impedance changing unit, and the second impedance changing unit in conjunction,
wherein the drive unit switches the first switching unit and the second switching unit in conjunction with each other, and changes the impedance of the first impedance changing unit and the impedance of the second impedance changing unit in conjunction with the switching operations of the first switching unit and second switching unit.

3. The on-load tap changing apparatus according to claim 1, wherein:
the first and second impedance changing units are each an inductor that include a coil wound around a cylindrical bobbin, and a core that moves inside the cylindrical bobbin; and
a movement of the core inside the bobbin changes relative positions between the core and the coil, and changes the impedance of the inductor.

4. The on-load tap changing apparatus according to claim 3, wherein:
the coil of the first impedance changing unit and the coil of the second impedance changing unit are connected in series via a neutral-point and wound around the bobbin; and
the core is a single core which changes a position relative to the coil of the first impedance changing unit and the coil of the second impedance changing unit in accordance with the switching operations of the first switching unit and second switching unit, and which moves inside the bobbin.

5. The on-load tap changing apparatus according to claim 4, wherein:
the bobbin is formed in a shape that draws a circular arc in a height direction of the cylindrical shape which interconnects openings;
the core is formed in a shape that draws a circular arc in a height direction of a cylinder shape;
the core is fastened to an arm rotatable around an axis; and
the core moves inside the bobbin by a rotation of the arm around the axis.

6. An on-load tap changing system comprising:
an on-load tap changing apparatus that comprises:
a first switching unit connected to a first tap of a transformer provided in a power system, and a power supplied from the first tap;
a first impedance changing unit connected in series with the first switching unit, and increasing an impedance when the first switching unit executes a switching operation;
a second switching unit connected to a second tap of the transformer, and switching a power supplied from the second tap; and
a second variable impedance unit connected in series with the second switching unit, and increasing an impedance when the second switching unit executes a switching operation;
a first main switch contact connected in parallel with the first switching unit of the on-load tap changing apparatus; and
a second main switch contact connected in parallel with the second switching unit of the on-load tap changing apparatus, wherein:
the first impedance unit of the on-load tap changing apparatus becomes higher impedance than an impedance of the first main switch contact when the first switching unit executes a switching operation, and becomes lower impedance than the impedance of the first main switch contact when becoming low impedance; and
the second impedance changing unit of the on-load tap changing apparatus becomes higher impedance than an impedance of the second main switch contact when the second switching unit executes a switching operation, and becomes lower impedance than the impedance of the second main switch contact when becoming low impedance.

7. The on-load tap changing system according to claim 6, wherein the first main switch contact and the second main switch contact each include a semiconductor switch.
